(19) United States
(12) Patent Application Publication
(10) Pub. No.: US 2026/0080695 A1
(43) Pub. Date: Mar. 19, 2026

(54) METHOD AND SYSTEM FOR AUTOMATIC MITOSIS DETECTION BASED ON DATA AND FEATURE DIVERSITY

(71) Applicant: GUANGDONG PROVINCIAL PEOPLE'S HOSPITAL, Guangzhou (CN)

(72) Inventors: Zaiyi LIU, Guangzhou (CN); Chu HAN, Guangzhou (CN); Hao WANG, Guangzhou (CN); Jiatai LIN, Guangzhou (CN); Guoqiang HAN, Guangzhou (CN)

(21) Appl. No.: 19/398,027

(22) Filed: Nov. 23, 2025

Related U.S. Application Data
(63) Continuation of application No. PCT/CN2023/129744, filed on Nov. 3, 2023.

(30) Foreign Application Priority Data
Aug. 17, 2023 (CN) 202311039397.0

(51) Int. Cl. G06V 20/69; G06T 7/00; G06T 7/11; G06V 10/26; G06V 10/72; G06V 10/762; G06V 10/764; G06V 10/77; G06V 10/774; G06V 10/776

(52) U.S. Cl. CPC G06V 20/698; G06T 7/0012; G06T 7/11; G06V 10/273; G06V 10/72; G06V 10/7625; G06V 10/764; G06V 10/7715; G06V 10/7747; G06V 10/776; G06V 20/695; G06T 2207/20081; G06T 2207/30024; G06T 2207/30096

(57) ABSTRACT

A method for automatic mitosis detection based on data and feature diversity is provided, in which a training-free hematoxylin-based detection approach is employed to obtain candidate samples; a balanced sampling strategy is applied to remove redundant information from the candidate samples, balance the data volume, and maintain sample diversity and eliminate easy samples, so as to obtain balanced and representative training dataset that facilitate a classifier in learning representative features; in view of the morphological complexity of mitotic cells, a jointly trained classifier is designed, in which subclass division is performed based on binary classification, the divided subclasses are used as pseudo-labels, and the classifier is trained with parent-class labels and subclass pseudo-labels to obtain a parent-subclass joint classifier. A system for implementing such method is also provided.

### CROSS-REFERENCE TO RELATED APPLICATIONS

This application is a continuation of International Patent Application No. PCT/CN2023/129744, filed on Nov. 3, 2023, which claims the benefit of priority from Chinese Patent Application No. 202311039397.0, filed on Aug. 17, 2023. The content of the aforementioned application, including any intervening amendments thereto, is incorporated herein by reference in its entirety.

### TECHNICAL FIELD

This application relates to image processing and mitosis detection, and more particularly to a method and system for automatic mitosis detection based on data and feature diversity.

### BACKGROUND

Mitosis is closely associated with the cell proliferation, and is considered as an important indicator for determining tumor grade and prognosis. Due to the rapid development of deep learning technologies, various segmentation models, object detection models, and classification models have been applied to automatic mitosis detection tasks, which can be broadly categorized into single-stage and multi-stage approaches. Single-stage methods employ end-to-end learning to directly produce final detection results, such as by treating mitosis detection as a semantic segmentation problem. Multi-stage methods typically consist of two phases: the first phase generates candidate cells while ensuring high recall rates, and the second phase further classifies these candidate cells. In existing techniques, a common multi-stage solution for automatic mitosis detection involves: (1) generating pixel-level pseudo-labels through additional manual pixel annotations or using existing models (e.g., HoVer-Net nuclear segmentation network); (2) training a segmentation network with the pixel-level pseudo-labels to preliminarily obtain candidate cells from input images while maintaining a high recall rate (aiming to identify as many mitotic cells as possible); and (3) classifying the candidate cells to yield the final results.

However, the existing methods have the following drawbacks. (1) Existing methods rely on complex segmentation models to obtain candidate cells, and these sophisticated models typically require higher-level annotations. Consequently, training such segmentation models often necessitates additional annotations (such as manual annotations or pseudo-labels generated by existing models) to acquire candidate cells, resulting in low efficiency. (2) In the existing methods, the data used for training the classification network remain imbalanced. These methods often rely on random sampling or employ specific loss functions to mitigate class imbalance. However, such approaches reduce data diversity and are inefficient, making it difficult for the classification model to effectively learn representative features. For instance, random sampling may discard some representative data during the selection process and fail to yield information-balanced samples, while applying specific loss functions to large datasets can only slightly alleviate the imbalance problem, as the model still tends to focus excessively on high-frequency class samples. (3) The classification models adopted in existing methods attempt to address mitosis detection by increasing model complexity, such as through ensemble learning or deeper networks, to improve classification performance. However, relying solely on complex classification models for detection easily leads to overfitting and results in poor generalization performance.

### SUMMARY

An object of the disclosure is to provide a method and apparatus for automatic mitosis detection based on data and feature diversity to overcome the defects in the prior art. Candidate cells are obtained through hematoxylin-based detection, and easy-to-classify samples are removed via diversity-based sample screening to generate a balanced set of samples. Finally, on the basis of binary classification, the samples are further divided into subclasses, and a classification model is trained based on mitosis prior knowledge to effectively improve classification performance.

Technical solutions of the present disclosure are described as follows.

In a first aspect, this application provides a method for automatic mitosis detection based on data and feature diversity, comprising:

(1) acquiring a pathological image and point annotations of the pathological image;
performing hematoxylin-eosin (HE) staining on the pathological image to obtain a stained pathological image;
processing the stained pathological image by color deconvolution to obtain a hematoxylin-stained channel image; and
dividing the hematoxylin-stained channel image into image patches as candidate cells, and classifying the candidate cells into a positive sample set and a negative sample set;
(2) filtering out redundant samples and easy samples from the negative sample set; and mixing remaining samples in the negative sample set with the positive sample set to obtain a training set;
(3) expanding the training set into k color spaces followed by mixing with the training set to form a training dataset;
(4) clustering the training dataset based on a deep learning network using parent-class labels to obtain subclass pseudo-labels; and optimizing the deep learning network based on the parent-class labels and the subclass pseudo-labels until a loss function converges, so as to obtain a parent-subclass joint classifier; and
(5) detecting mitosis in a to-be-detected pathological image using the parent-subclass joint classifier to obtain a detection result.

In some embodiments, the step (1) comprises:
acquiring a pathological image I and point annotations of the pathological image I, wherein the pathological image I contains a cells;
performing HE staining on the pathological image I to obtain a stained pathological image;
processing the stained pathological image I by color deconvolution to obtain a hematoxylin-stained channel image Iₕ;
obtaining a centroid coordinate O of each of the a cells from the hematoxylin-stained channel image Iₕ;
based on the centroid coordinate O, segmenting the hematoxylin-stained channel image In into a image patches respectively corresponding to the a cells to obtain an image patch set D_{H}={I₁, I₂, . . . , Iₐ}; and
classifying the image patch set D_{H}={I₁, I₂, . . . , Iₐ} into a positive sample set D^{P} and a negative sample set D^{N} according to the point annotations of the pathological image I;
wherein the point annotations of the pathological image I comprise a mitotic point annotation and a non-mitotic point annotation; and
for image patches in the image patch set D_{H}={I₁, I₂, . . . , Iₐ} with the mitotic point annotation located therein, these image patches are categorized into the positive sample set D^{P}; and image patches without the mitotic point annotation are categorized into the negative sample set D^{N}.

In some embodiments, the step (2) comprises:
clustering the negative sample set D^{N} into k subspace clusters to form a subspace cluster set C={C₁, C₂, . . . , Cₖ} using a K-means clustering algorithm, wherein

$${C}_{k} = \{ {X}_{k}^{1} , {X}_{{C}_{k}}^{2} , ... , {X}_{{C}_{k}}^{{a}_{k}} \} , {X}_{{C}_{k}}^{{a}_{k}} ∈ {D}^{N}$$

represents a aₖ-th sample belonging to a k-th subspace cluster, and aₖ denotes the number of samples in the k-th subspace cluster;
selecting m negative samples from each of the k subspace clusters to form a diversity-selected negative sample set

$${D}_{diversity}^{N} ,$$

wherein

$${D}_{diversity}^{N} = \{ {C}_{1}^{′} , {C}_{2}^{′} , ... , {C}_{k}^{′} \} ,$$

$${C}_{k}^{′} = \{ {X}_{{C}_{k}}^{{1}^{′}} , {X}_{{C}_{k}}^{{2}^{′}} , ... , {X}_{{C}_{k}}^{m} \} , and {X}_{{C}_{k}}^{m}$$

denotes a m-th negative sample selected from the k-th subspace cluster;
training a classification network f_{easy-sampling} based on the positive sample set D^{P} and the diversity-selected negative sample set

$${D}_{diversity}^{N} ;$$

and filtering out easy samples from the diversity-selected negative sample set

$${D}_{diversity}^{N}$$

using the classification network f_{easy-sampling}, wherein hard-to-distinguish negative samples left in the diversity-selected negative sample set

$${D}_{diversity}^{N}$$

constitute a negative sample set

$${D}_{select}^{N} ;$$

mixing the positive sample set D^{P} with the negative sample set

$${D}_{select}^{N}$$

to obtain a training set

$$D = \{ {D}^{P} , {D}_{select}^{N} \} .$$

In some embodiments, the parent-subclass joint classifier is constructed based on the deep learning network, and comprises an input layer, a feature extractor, a parent-class classifier, a subclass classifier and an output layer;
the input layer is connected to the feature extractor; the feature extractor is connected to the parent-class classifier and the subclass classifier; a fully connected layer of the parent-class classifier is configured as a final fully connected layer to be sequentially connected to the feature extractor and the output layer;
wherein the step (4) comprises:
inputting the training dataset into the input layer; extracting, by the feature extractor, features from the training dataset; and inputting extracted features into the parent-class classifier;
classifying, by the parent-class classifier, the extracted features to obtain the parent-class labels, wherein the parent-class labels comprise a mitotic class and a non-mitotic class;
performing binary classification training on the feature extractor using the training dataset based on the parent-class labels to obtain a preliminarily-trained feature extractor;
extracting, by the preliminarily-trained feature extractor, features of samples from the training dataset to obtain sample features;
clustering, by the subclass classifier, the sample features to divide the mitotic class and the non-mitotic class in the parent-class labels into a plurality of subclasses with the same sample number as the subclass pseudo-labels; and
training the preliminarily-trained feature extractor using the parent-class labels and the subclass pseudo-labels until the loss function converges or an accuracy requirement is met, so as to obtain the parent-subclass joint classifier.

In some embodiments, each of the parent-class labels is represented by c={cₚ, cₙ}, wherein cₚ represents the mitotic class and cₙ represents the non-mitotic class;
samples belonging to each of the parent-class labels c={cₚ, cₙ} are clustered using an unsupervised clustering algorithm into T subclasses

$${S}_{c}^{t} , t = \{ 1 , 2 , ... , T \}$$

as the subclass pseudo-labels; and
assuming that a parent-class label for each of the samples in the training dataset is denoted as Y_{P}, a pseudo subclass label corresponding to each of the T subclasses in each of the parent-class labels c is denoted as Y_{S}, and a clustering objective for each of the parent-class labels c is expressed as:

$$min \frac{1}{{N}^{c}} {\sum }_{i = 1}^{{N}^{c}} {min}_{{Y}_{S}} {‖ E ( \hat{D} ) - {OY}_{S} ‖}_{2}^{2} , s . t . {{Y}_{S}}^{T} {1}_{t} = 1 ;$$

wherein N^{c} is the number of samples in each of the parent-class labels c, Y_{S} is the pseudo subclass label, \hat{D} is the training dataset, E(\hat{D}) represents the features of the training dataset extracted by the feature extractor, O is a matrix composed of centroid coordinates of cells in the training dataset, and 1ₜ represents a t-dimensional identity vector.

In some embodiments, the parent-class classifier and the subclass classifier are supervised using a focal loss function and a center loss function;
a loss function L_{P} for a parent-class classifier f_{P} is defined as:

$${L}_{P} = {L}_{{P}_{f}} + {L}_{{P}_{c}} ;$$

wherein L_{P}_{_{f}} is a focal loss function for the parent-class classifier f_{P}, and L_{P}_{_{c}} is a center loss function for the parent-class classifier f_{P};
a loss function L_{S} for a subclass classifier f_{S} is defined as:

$${L}_{S} = {L}_{{S}_{f}} + {L}_{{S}_{c}} ;$$

wherein L_{S}, is a focal loss function for the subclass classifier f_{S}, and L_{S}_{_{c}} is a center loss function for the subclass classifier f_{S}; and
the feature extractor is optimized using the loss function L_{P} and the loss function L_{S}, and a loss function for the feature extractor is expressed as:

$$min \frac{1}{N} {\sum }_{i = 1}^{N} {L}_{P} ( {f}_{P} ( E ( \hat{D} ) , {θ}_{P} ) , {Y}_{P} ) + λ {L}_{S} ( {f}_{S} ( E ( \hat{D} ) , {θ}_{S} ) , {Y}_{S} ) ;$$

wherein N is the number of samples in the training dataset, \hat{D} is the training dataset, E(\hat{D}) represents the features of the training dataset extracted by the feature extractor, A is a balancing parameter, θ_{P} is a parameter of the parent-class classifier f_{P}, θ_{S} is a parameter of the subclass classifier f_{S}, Y_{P} is a parent-class label, and Y_{S} is a pseudo subclass label.

In some embodiments, the focal loss function is expressed as:

$${L}_{F} = - {\sum }_{i} [ {( 1 - {\hat{y}}_{ι} )}^{γ} {y}_{i} log {\hat{y}}_{ι} + {( {\hat{y}}_{ι} )}^{γ} ( 1 - {y}_{i} ) log ( 1 - {\hat{y}}_{ι} ) ] ;$$

wherein yᵢ represents a label of an i-th sample in the training dataset, and ŷᵢ represents a prediction of the i-th sample in the training dataset, and γ is an adjustable parameter for controlling a weight of misclassified samples; and
the center loss function is expressed as:

$${L}_{C} = \frac{1}{2} {\sum }_{i = 1}^{N} {‖ {x}_{i} - {c}_{{y}_{i}} ‖}_{2}^{2} ;$$

wherein xᵢ is a feature vector of the i-th sample in the training dataset, yᵢ is a subclass label corresponding to the feature vector xᵢ, N is the number of samples in the training dataset, and c_{y}_{ᵢ} is a center of an i-th subclass.

In a second aspect, this application provides a system for implementing the method described above, comprising:
a staining detection module;
a sample selection module;
a data augmentation module;
a classifier training module; and
a detection result module;
wherein the staining detection module is configured to perform:
   acquiring the pathological image and point annotations of the pathological image;
   performing HE staining on the pathological image to obtain the stained pathological image;
   processing the stained pathological image by color deconvolution to obtain the hematoxylin-stained channel image; and
   dividing the hematoxylin-stained channel image into image patches as candidate cells, and classifying the candidate cells into the positive sample set and the negative sample set;
the sample selection module is configured to perform:
   filtering out redundant samples and easy samples from the negative sample set; and
   mixing remaining samples in the negative sample set with the positive sample set to obtain the training set;
the data augmentation module is configured to perform:
   expanding the training set into k color spaces followed by mixing with the training set to form the training dataset;
the classifier training module is configured to perform:
   clustering the training dataset based on the deep learning network using parent-class labels to obtain subclass pseudo-labels; and
   optimizing the deep learning network based on the parent-class labels and the subclass pseudo-labels until the loss function converges, so as to obtain the parent-subclass joint classifier; and
the detection result module is configured to detect mitosis in the to-be-detected pathological image using the parent-subclass joint classifier to obtain the detection result.

In a third aspect, this application provides an electronic device, comprising:
at least one processor; and
a memory communicatively coupled to the at least one processor;
wherein the memory is configured for storing computer program instructions executable by the at least one processor; and the computer program instructions are configured to be executed by the at least one processor to implement the method described above.

In a fourth aspect, this application provides a non-transitory computer-readable storage medium;
wherein the non-transitory computer-readable storage medium is configured for storing a computer program; and the computer program is configured to be executed by a processor to implement the method described above.

Compared to the prior art, the present disclosure has the following beneficial effects.

(1) The hematoxylin-based detection method in the present disclosure offers advantages of requiring neither training nor additional annotation. In existing methods, mitotic candidate cells are obtained through segmentation or detection models, which demand considerable time and extra annotations. These methods train the models using additional bounding-box-level or pixel-level annotations and employ complex models to detect mitoses, designating the detected cells as candidate cells. In contrast, the present disclosure determines mitotic candidate cells based on mitosis prior knowledge that mitosis typically occurs within the cell nucleus. By performing color deconvolution to separate the hematoxylin (H) channel, a distribution map of cell nuclei is obtained, and the centroids of the nuclei are located based on the H channel to identify mitotic candidate cells. This approach requires no model training, and the hematoxylin-based detection method can detect the vast majority of mitotic cells, naturally achieving a high recall rate.

(2) The diversity-based sample screening method in the present disclosure enables the acquisition of more balanced and representative training samples. Considering the extreme imbalance of mitotic samples, the method specifically balances the quantity, diversity, and difficulty level of training samples. Mitotic samples are selected in the clustered feature space, and the clustered samples are divided into a plurality of subclasses, and an equal number of samples is selected from each of the plurality of subclasses. While removing redundant data, sample diversity is preserved. A classifier is then used to eliminate easy samples from the selected set, thereby balancing the information content of the samples and facilitating the model in learning more representative features.

(3) The present disclosure introduces a parent-subclass joint classifier that incorporates a subclass classification task on top of binary classification. The parent-subclass joint classifier is trained using both parent-class labels and subclass labels to learn more diverse information. Based on mitosis prior knowledge, and considering the morphological differences among prophase, metaphase, anaphase, and telophase, which vary significantly across mitotic stages, the present disclosure further subdivides classes into subclasses within each parent class. This allows the model to focus on more detailed mitotic information, thereby improving classification performance. Compared with existing binary classification methods, the present disclosure takes into account the characteristics of mitosis and designs the model based on prior knowledge, achieving more efficient performance.

### BRIEF DESCRIPTION OF THE DRAWINGS

In order to illustrate the technical solutions in the present disclosure more clearly, the accompanying drawings needed in the description of the embodiments will be briefly described below. It is evident that presented in the accompanying drawings described below are only some embodiments of the present disclosure. For those of ordinary skill in the art, other accompanying drawings can be obtained based on these accompanying drawings without making creative effort.

FIG. 1 is a flowchart of a method for automatic mitosis detection based on data and feature diversity according to an embodiment of the present disclosure;

FIG. 2 is a structural diagram of a system for automatic mitosis detection based on data and feature diversity according to an embodiment of the present disclosure; and

FIG. 3 is a structural diagram of an electronic device according to an embodiment of the present disclosure.

### DETAILED DESCRIPTION OF EMBODIMENTS

In order to make the objects, technical solutions and advantages of the present disclosure clearer, the present disclosure will be described clearly and completely below in conjunction with the accompanying drawings and embodiments. Obviously, described herein are merely some embodiments of the present disclosure, rather than all embodiments. Based on the embodiments in the present disclosure, all other embodiments obtained by those of ordinary skill in the art without making creative effort shall fall within the scope of the present disclosure defined by the appended claims.

As used herein, the term “embodiment” means that a particular feature, structure or characteristic described in connection with an embodiment may be included in at least one embodiment of the present disclosure. The appearance of this term at various locations in the specification does not necessarily refer to the same embodiment, nor does it imply mutually exclusive or alternative embodiments. It will be understood by those skilled in the art, both explicitly and implicitly, that the embodiments described herein may be combined with other embodiments.

Automatic mitosis detection refers to the use of computer vision techniques to locate and identify mitotic cells in pathological images. The main technical challenges in automatic mitosis detection involve two aspects: first, extreme data imbalance, and second, the complex morphological structure of mitotic cells. On one hand, pathological images differ from natural images in that they contain a large number of pixels and cover a wide field of view, whereas mitotic cells typically occupy only tens of pixels, making them small targets. Therefore, automatic mitosis detection is a task of detecting small targets within a large field of view. Additionally, mitotic cells are sparsely distributed, with the majority of cells in an image being non-mitotic, resulting in extremely imbalanced samples that contain a large number of non-mitotic cells and only a few mitotic cells. On the other hand, mitotic cells are difficult to distinguish due to their complex morphological structure, which includes multiple stages, including prophase, metaphase, anaphase and telophase, each of which has distinct morphological features. Moreover, some dense non-mitotic nuclei and apoptotic cells are highly similar to mitotic cells, further increasing the difficulty of accurate identification and detection.

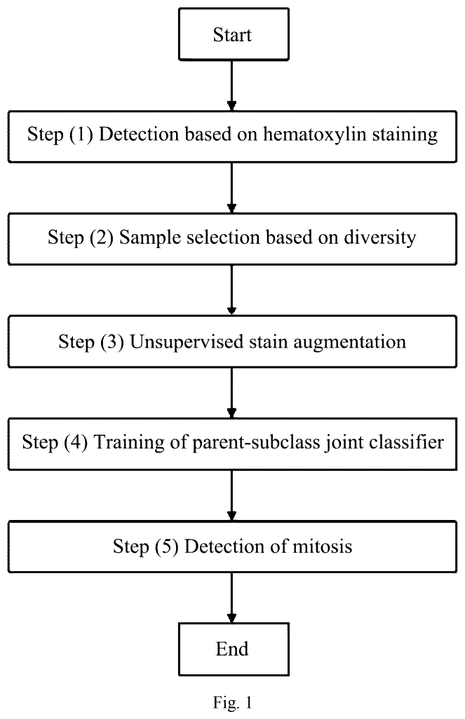

In view of this, as shown in FIG. 1, an embodiment of the present disclosure provides a method for automatic mitosis detection based on data and feature diversity, including the following steps.

### Step (1) Detection Based on Hematoxylin Staining

A pathological image and point annotations of the pathological image are acquired. Hematoxylin-eosin (HE) staining is performed on the pathological image to obtain a stained pathological image. The stained pathological image is processed by color deconvolution to obtain a hematoxylin-stained channel image. The hematoxylin-stained channel image is divided into image patches as candidate cells. The candidate cells are classified into a positive sample set and a negative sample set.

HE staining is a commonly used histopathological image staining technique, in which hematoxylin (H) stains nuclei blue and eosin (E) stains cytoplasm red. In this embodiment, the stained pathological image is separated to obtain the H channel image, from which candidate cell are obtained. The step (1) includes the following steps.

Step (1.1) A pathological image I and point annotations of the pathological image I are acquired, where the pathological image I contains a cells.

Step (1.2) HE staining is performed on the pathological image I to obtain a stained pathological image I.

Step (1.3) Due to the interaction between hematoxylin and cell nuclei, the nuclei appear blue. The stained pathological image I is processed by color deconvolution to obtain a hematoxylin-stained channel image In.

Step (1.4) A centroid coordinate O of each of the a cells is obtained from the hematoxylin-stained channel image In.

Step (1.5) Based on the centroid coordinate O, the hematoxylin-stained channel image In is segmented into a image patches respectively corresponding to the a cells to obtain an image patch set D_{H}={I₁, I₂, . . . , Iₐ}, forming a set of candidate cells.

Step (1.6) The image patch set D_{H}={I₁, I₂, . . . , Iₐ} is classified into a positive sample set D^{P} and a negative sample set D^{N} according to the point annotations of the pathological image I.

The point annotations of the pathological image I include a mitotic point annotation and a non-mitotic point annotation. For image patches in the image patch set D_{H}={I₁, I₂, . . . , Iₐ} with the mitotic point annotation located therein, these image patches are categorized into the positive sample set D^{P}; and image patches without the mitotic point annotation are categorized into the negative sample set D^{N}.

### Step (2) Sample Selection Based on Diversity

Redundant samples and easy samples from the negative sample set are filtered out. Remaining samples in the negative sample set are mixed with the positive sample set to obtain a training set.

The image patches obtained in step (1) suffer from data imbalance, with negative samples outnumbering positive samples. In the prior art, simple random sampling is used to balance the samples without considering their diversity, causing a loss of a small number of representative samples during random selection. In this embodiment, sample selection is performed based on diversity to eliminate redundancy and obtain informative samples, thereby ensuring sample diversity. The step (2) includes the following steps.

Step (2.1) The negative sample set D^{N} is clustered into k subspace clusters to form a subspace cluster set C={C₁, C₂, . . . , Cₖ} using a K-means clustering algorithm, where

$${C}_{k} = \{ {X}_{k}^{1} , {X}_{{C}_{k}}^{2} , ... , {X}_{{C}_{k}}^{{a}_{k}} \} , {X}_{{C}_{k}}^{{a}_{k}} ∈ {D}^{N}$$

represents a aₖ-th sample belonging to a k-th subspace cluster, and aₖ denotes the number of samples in the k-th subspace cluster.

Step (2.2) m negative samples are selected from each of the k subspace clusters to form a diversity-selected negative sample set

$${D}_{diversity}^{N} ,$$

where

$${D}_{diversity}^{N} = \{ {C}_{1}^{′} , {C}_{2}^{′} , … , {C}_{k}^{′} \} , {C}_{k}^{′} = \{ {X}_{{C}_{k}}^{{1}^{′}} , {X}_{{C}_{k}}^{{2}^{′}} , … , {X}_{{C}_{k}}^{m} \} , and {X}_{{C}_{k}}^{m}$$

denotes a m-th negative sample selected from the k-th subspace cluster.

Step (2.3) To remove a large number of easy samples from the negative samples, a classification network f_{easy-sampling} is trained based the positive sample set D^{P} and the diversity-selected negative sample set

$${D}_{diversity}^{N} .$$

Easy samples from the diversity-selected negative sample set

$${D}_{diversity}^{N}$$

are filtered out using the classification network f_{easy-sampling}, where hard-to-distinguish negative samples left in the diversity-selected negative sample set

$${D}_{diversity}^{N}$$

constitute a negative sample set

$${D}_{select}^{N} .$$

Step (2.4) The positive sample set D^{P} is mixed with the negative sample set

$${D}_{select}^{N}$$

to obtain a training set

$$D = \{ {D}^{P} , {D}_{select}^{N} \} .$$

### Step (3) Unsupervised Staining Augmentation

The training set is expanded into k color spaces and then mixed with the training set to form a training dataset.

### Step (4) Training of Parent-Subclass Joint Classifier

The training dataset are clustered based on a deep learning network using parent-class labels to obtain subclass pseudo-labels. The deep learning network is optimized based on the parent-class labels and the subclass pseudo-labels until a loss function converges, so as to obtain a parent-subclass joint classifier.

In existing methods, the mitosis detection task is treated as a binary classification problem, ignoring the complex morphological characteristics of mitotic cells. As a result, such models fail to learn robust feature representations. To address this issue, a subclass classification task is added on top of the binary classification framework in this disclosure, enabling the model to learn more diverse and informative features.

The parent-subclass joint classifier is constructed based on the deep learning network, and includes an input layer, a feature extractor, a parent-class classifier, a subclass classifier and an output layer. The input layer is connected to the feature extractor. The feature extractor is connected to the parent-class classifier and the subclass classifier. A fully connected layer of the parent-class classifier is configured as a final fully connected layer to be sequentially the feature extractor and the output layer.

The step (4) includes the following steps.

The training dataset are input into the input layer. Features from the training dataset are extracted by the feature extractor. Extracted features are input into the parent-class classifier.

The extracted features are classified by the parent-class classifier to obtain the parent-class labels, where the parent-class labels include a mitotic class and a non-mitotic class.

Based on the parent-class labels, binary classification training is performed on the feature extractor using the training dataset to obtain a preliminarily-trained feature extractor.

Features of samples from the training dataset are extracted by the preliminarily-trained feature extractor to obtain sample features.

The sample features are clustered by the subclass classifier to divide the mitotic class and the non-mitotic class in the parent-class labels into a plurality of subclasses with the same sample number as the subclass pseudo-labels.

The preliminarily-trained feature extractor is trained using the parent-class labels and the subclass pseudo-labels until the loss function converges or an accuracy requirement is met, so as to obtain the parent-subclass joint classifier.

In some embodiments, each of the parent-class labels is represented by c={cₚ, cₙ}, where cₚ represents the mitotic class and cₙ represents the non-mitotic class. Samples belonging to each of the parent-class labels c={cₚ, cₙ} are clustered using an unsupervised clustering algorithm into T subclasses

$${S}_{c}^{t} , t = \{ 1 , 2 , … , T \}$$

as the subclass pseudo-labels.

Assuming that a parent-class label for each of the samples in the training dataset is denoted as Y_{P}, a pseudo subclass label corresponding to each of the T subclasses in each of the parent-class labels c is denoted as Y_{S}, and a clustering objective for each of the parent-class labels c is expressed as:

$$min \frac{1}{{N}^{c}} {\sum }_{i = 1}^{{N}^{c}} {min}_{{Y}_{S}} {‖ E ( \hat{D} ) - {OY}_{S} ‖}_{2}^{2} , s . t . {Y}_{S}^{T} {1}_{t} = 1.$$

In the above formula, N^{c} is the number of samples in each of the parent-class labels c, Y_{S} is the pseudo subclass label, \hat{D} is the training dataset, E(\hat{D}) represents the features of the training dataset extracted by the feature extractor, O is a matrix composed of centroid coordinates of cells in the training dataset, and 1ₜ represents a t-dimensional identity vector.

In some embodiments, the parent-class classifier and the subclass classifier are supervised using a focal loss function and a center loss function.

A loss function L_{P} for a parent-class classifier f_{P} is defined as:

$${L}_{P} = {L}_{{P}_{f}} + {L}_{{P}_{c}} .$$

In the above formula, L_{P}_{_{f}} is a focal loss function for the parent-class classifier f_{P}, and L_{P}_{_{c}} is a center loss function for the parent-class classifier f_{P}.

A loss function L_{S} for a subclass classifier f_{S} is defined as:

$${L}_{S} = {L}_{{S}_{f}} + {L}_{{S}_{c}} .$$

In the above formula, L_{S}_{_{f}} is a focal loss function for the subclass classifier f_{S}, and L_{S}_{_{c}} is a center loss function for the subclass classifier f_{S}.

The feature extractor is optimized using the loss function L_{P} and the loss function L_{S}, and a loss function for the feature extractor is expressed as:

$$min \frac{1}{N} {\sum }_{i = 1}^{N} {L}_{P} ( {f}_{P} ( E ( \hat{D} ) , {θ}_{P} ) , {Y}_{P} ) + λ {L}_{S} ( {f}_{S} ( E ( \hat{D} ) , {θ}_{S} ) , {Y}_{S} ) .$$

In the above formula, N is the number of samples in the training dataset, \hat{D} is the training dataset, E(\hat{D}) represents the features of the training dataset extracted by the feature extractor, λ is a balancing parameter, θ_{P} is a parameter of the parent-class classifier f_{P}, θ_{S} is a parameter of the subclass classifier f_{S}, Y_{P} is a parent-class label, and Y_{S} is a pseudo subclass label.

In this embodiment, to enable the model to focus on hard-to-distinguish samples, the focal loss function and the center loss function are employed to simultaneously increase the inter-class distance and reduce the intra-class distance for both parent classes and subclasses. The focal loss function reduces the weights of easy samples and pays more attention to the hard-to-distinguish samples, which is expressed as follows:

$${L}_{F} = - {\sum }_{i} [ {( 1 - \hat{{y}_{ι}} )}^{γ} {y}_{i} log \hat{{y}_{ι}} + {( \hat{{y}_{ι}} )}^{γ} ( 1 - {y}_{i} ) log ( 1 - \hat{{y}_{ι}} ) ] .$$

In the above formula, yᵢ represents a label of an i-th sample in the training dataset, and ŷᵢ represents a prediction of the i-th sample in the training dataset, and γ is an adjustable parameter for controlling a weight of misclassified samples.

The center loss function reduces the intra-class distance by encouraging the feature vectors of samples belonging to the same class to approach their corresponding class centers, which is expressed as:

$${L}_{C} = \frac{1}{2} {\sum }_{i = 1}^{N} {‖ {x}_{i} - {c}_{{y}_{i}} ‖}_{2}^{2} .$$

In the above formula, xᵢ is a feature vector of the i-th sample in the training dataset, yᵢ is a subclass label corresponding to the feature vector xᵢ, N is the number of samples in the training dataset, and c_{y}_{ᵢ} is a center of an i-th subclass.

To verify the effectiveness and advancement of the method provided herein, experiments are conducted on the MIDOG2021 dataset. An image with a size of 5412×7215 pixels is input into the hematoxylin-based detector to obtain mitotic candidate image patches, each having a size of 80×80 pixels. Based on point annotations, these image patches are classified into mitotic image patches and non-mitotic image patches. The non-mitotic image patches are clustered into ten categories using a ResNet38 network pre-trained on ImageNet, and 3,000 image patches are selected from each category, resulting in a total of 30,000 non-mitotic image patches. A ResNet38 classification network is trained using the non-mitotic image patches and the mitotic image patches. Easy samples are filtered out from the non-mitotic image patches using the trained ResNet38 classification network. The remaining image patches in the non-mitotic image patches are mixed with the mitotic image patches to obtain a training set. The training set is expanded through stain normalization into three different color domains, and the expanded training dataset are combined with the training set to form a training dataset. The training dataset are input into a new ResNet38 network for training to obtain a feature extractor. Features from the training dataset are extracted using the feature extractor. The mitotic data and non-mitotic data are divided into four subclasses based on the extracted features. The subclass results are used as subclass pseudo-labels for the training dataset. The parent-class labels and subclass pseudo-labels are supervised respectively using the focal loss function and the center loss function, thereby obtaining the parent-subclass joint classifier.

It should be noted that, for the aforementioned embodiments of the methods, for ease of description, they are all expressed as a series of combined actions. However, those skilled in the art should understand that the present disclosure is not limited to the described order of actions, as certain steps may be performed in a different order or simultaneously according to the present disclosure.

Based on the same concept as the above-described embodiments of the method for automatic mitosis detection based on data and feature diversity, the present disclosure further provides a system for automatic mitosis detection based on data and feature diversity. The system is configured to implement the above-described method. For ease of illustration, only the components related to the present embodiment are shown in the schematic diagram of the system. Those skilled in the art will understand that the illustrated structure does not constitute a limitation of the apparatus, and the system may include more or fewer components than shown, or some components may be combined, or components may be arranged differently.

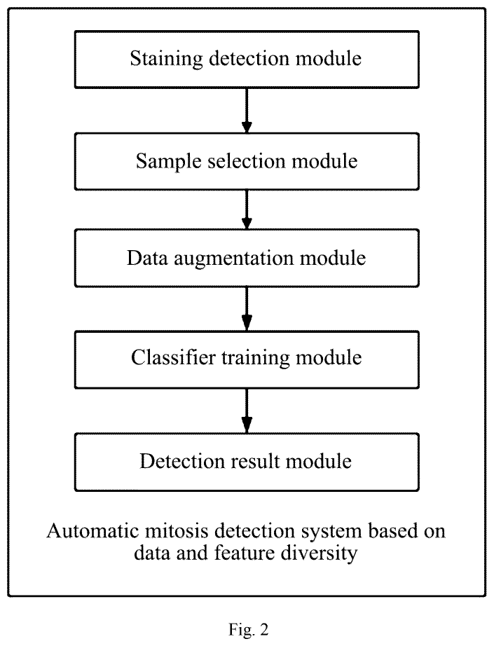

As shown in FIG. 2, the present disclosure also provides a system for automatic mitosis detection based on data and feature diversity, including a staining detection module, a sample selection module, a data augmentation module, a classifier training module and a detection result module.

The staining detection module is configured to perform:
acquiring the pathological image and point annotations of the pathological image;
performing HE staining on the pathological image to obtain the stained pathological image;
processing the stained pathological image by color deconvolution to obtain the hematoxylin-stained channel image; and
dividing the hematoxylin-stained channel image into image patches as candidate cells, and classifying the candidate cells into the positive sample set and the negative sample set.

The sample selection module is configured to perform:
filtering out redundant samples and easy samples from the negative sample set; and
mixing remaining samples in the negative sample set with the positive sample set to obtain the training set.

The data augmentation module is configured to perform:
expanding the training set into k color spaces followed by mixing with the training set to form the training dataset.

The classifier training module is configured to perform:
clustering the training dataset based on the deep learning network using parent-class labels to obtain subclass pseudo-labels; and
optimizing the deep learning network based on the parent-class labels and the subclass pseudo-labels until the loss function converges, so as to obtain the parent-subclass joint classifier.

The detection result module is configured to detect mitosis in the to-be-detected pathological image using the parent-subclass joint classifier to obtain the detection result.

It should be noted that the system provided herein corresponds one-to-one with the method described above. The technical features and beneficial effects described in the embodiments of the above-mentioned method are equally applicable to the embodiments of the system for automatic mitosis detection based on data and feature diversity. The specific contents can be referred to in the descriptions of the method embodiments, and will not be repeated herein. This is hereby stated.

In addition, in the embodiments of the system described above, the logical division of the program modules is provided merely by way of example. In actual applications, depending on requirements, such as corresponding hardware configurations or convenience of software implementation, the functions may be assigned to different program modules. That is, the internal structure of the system can be divided into different program modules to perform all or part of the functions described above.

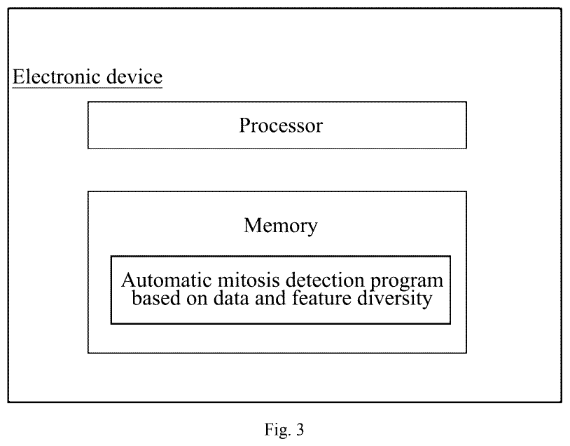

Referring to FIG. 3, in an embodiment, the present disclosure also provides an electronic device configured to implement the method described above. The electronic device may include a processor, a memory and a bus, and may further include a computer program stored in the memory and executable on the processor, such as an automatic mitosis detection program based on data and feature diversity.

The memory includes at least one type of readable storage medium, such as flash memory, a mobile hard drive, a multimedia card, card-type memory (e.g., SD or DX memory), magnetic storage, a disk and an optical disk. In some embodiments, the memory may serve as an internal storage unit of the electronic device, for example, the mobile hard drive of the electronic device. In some embodiments, the memory may be an external storage device of the electronic device, such as a plug-in mobile hard drive, a Smart Media Card (SMC), a Secure Digital (SD) card, or a flash card. Furthermore, the memory may include both an internal storage unit and external storage devices of the electronic device. The memory may be used not only to store application software and various types of data installed on the electronic device, such as code for the automatic mitosis detection program based on data and feature diversity, but also to temporarily store data that has been output or is about to be output.

In some embodiments, the processor may be composed of an integrated circuit, which can be composed of a single packaged integrated circuit or a combination of multiple packaged integrated circuits having the same or different functions. The processor may include one or more central processing units (CPUs), microprocessors, digital processing chips, graphics processors, or combinations of various control chips. The processor serves as the control core (Control Unit) of the electronic device, connecting all components of the electronic device via various interfaces and circuits. By executing or running programs or modules stored in the memory (such as the automatic mitosis detection program based on data and feature diversity) and accessing data stored in the memory, the processor performs various functions of the electronic device and processes the data accordingly.

FIG. 3 merely illustrates the electronic device with components. It should be understood by those skilled in the art that the structure shown in FIG. 3 does not limit the electronic device. The device may include fewer or more components than those illustrated, certain components may be combined, or the components may be arranged differently.

The automatic mitosis detection program based on data and feature diversity stored in the memory of the electronic device is a combination of a plurality of instructions, that, when executed by the processor, cause the electronic device to implement the following steps:
step (1) acquiring the pathological image and point annotations of the pathological image;
performing hematoxylin-eosin (HE) staining on the pathological image to obtain the stained pathological image;
processing the stained pathological image by color deconvolution to obtain the hematoxylin-stained channel image; and
dividing the hematoxylin-stained channel image into image patches as candidate cells, and classifying the candidate cells into the positive sample set and the negative sample set;
step (2) filtering out redundant samples and easy samples from the negative sample set; and
mixing remaining samples in the negative sample set with the positive sample set to obtain the training set;
step (3) expanding the training set into k color spaces followed by mixing with the training set to form the training dataset;
step (4) clustering the training dataset based on the deep learning network using parent-class labels to obtain subclass pseudo-labels; and
optimizing the deep learning network based on the parent-class labels and the subclass pseudo-labels until the loss function converges, so as to obtain the parent-subclass joint classifier; and
step (5) detecting mitosis in the to-be-detected pathological image using the parent-subclass joint classifier to obtain the detection result.

Furthermore, when the modules/units integrated within the electronic device are implemented in the form of software function units and are sold or used as independent products, they may be stored in a non-volatile computer-readable storage medium. The computer-readable medium may include any entity or device capable of carrying the computer program code, such as a recording medium, a USB flash drive, a portable hard disk, a disk, an optical disc, a computer memory, or a Read-Only Memory (ROM).

It can be understood by those skilled in the art that all or part of the processes of the above-described method embodiments may be implemented by instructing related hardware through a computer program. The program may be stored in a non-volatile computer-readable storage medium, and when executed, may include the steps of the method described above. In the embodiments provided herein, any reference to memory, storage, database, or other media may include both non-volatile and/or volatile memory. The non-volatile memory may include Read-Only Memory (ROM), Programmable ROM (PROM), electrically programmable ROM (EPROM), Electrically Erasable programmable ROM (EEPROM), or flash memory. The volatile memory may include Random Access Memory (RAM) or external cache memory. By way of example rather than limitation, RAM may be available in various forms, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), Rambus Direct RAM (RDRAM), Direct Rambus Dynamic RAM (DRDRAM), and Rambus Dynamic RAM (RDRAM).

The technical features of the above embodiments may be combined in any suitable manner. For the sake of brevity, not all possible combinations of the technical features described in the above embodiments are explicitly set forth. Nevertheless, any combination of these technical features that does not result in a contradiction should be considered within the scope of the disclosure as described herein.

The embodiments described above are merely preferred embodiments of the present disclosure, and are not intended to limit the scope of the present disclosure. Any equivalent structural changes made based on the description and the accompanying drawings of the present disclosure under the inventive concept of the present disclosure, or direct/indirect application in other related technical fields shall fall within the scope of the present disclosure defined by the appended claims.

What is claimed is:

1. A method for automatic mitosis detection based on data and feature diversity, comprising:
(1) acquiring a pathological image and point annotations of the pathological image;
performing hematoxylin-eosin (HE) staining on the pathological image to obtain a stained pathological image;
processing the stained pathological image by color deconvolution to obtain a hematoxylin-stained channel image; and
dividing the hematoxylin-stained channel image into image patches as candidate cells, and classifying the candidate cells into a positive sample set and a negative sample set;
(2) filtering out redundant samples and easy samples from the negative sample set; and
mixing remaining samples in the negative sample set with the positive sample set to obtain a training set;
(3) expanding the training set into k color spaces followed by mixing with the training set to form a stain-augmented training dataset;
(4) clustering the stain-augmented training dataset based on a deep learning network using parent-class labels to obtain subclass pseudo-labels; and
optimizing the deep learning network based on the parent-class labels and the subclass pseudo-labels until a loss function converges, so as to obtain a parent-subclass joint classifier; and
(5) detecting mitosis in a to-be-detected pathological image using the parent-subclass joint classifier to obtain a detection result.

2. The method of claim 1, wherein the step (1) comprises:
acquiring a pathological image I and point annotations of the pathological image I, wherein the pathological image I contains a cells;
performing HE staining on the pathological image I to obtain a stained pathological image I;
processing the stained pathological image I by color deconvolution to obtain a hematoxylin-stained channel image Iₕ;
obtaining a centroid coordinate O of each of the a cells from the hematoxylin-stained channel image Iₕ;
based on the centroid coordinate O, segmenting the hematoxylin-stained channel image Iₕ into a image patches respectively corresponding to the a cells to obtain an image patch set D_{H}={I₁, I₂, . . . , Iₐ}; and
classifying the image patch set D_{H}={I₁, I₂, . . . , Iₐ} into a positive sample set D^{P} and a negative sample set D^{N} according to the point annotations of the pathological image I;
wherein the point annotations of the pathological image I comprise a mitotic point annotation and a non-mitotic point annotation; and
for image patches in the image patch set D_{H}={I₁, I₂, . . . , Iₐ} with the mitotic point annotation located therein, these image patches are categorized into the positive sample set D^{P}; and image patches without the mitotic point annotation are categorized into the negative sample set D^{N}.

3. The method of claim 2, wherein the step (2) comprises:
clustering the negative sample set D^{N} into k subspace clusters to form a subspace cluster set C={C₁, C₂, . . . , Cₖ} using a K-means clustering algorithm, wherein
$${C}_{k} = \{ {X}_{k}^{1} , {X}_{{C}_{k}}^{2} , … , {X}_{{C}_{k}}^{{a}_{k}} \} , {X}_{{C}_{k}}^{{a}_{k}} ∈ {D}^{N}$$
represents a aₖ-th sample belonging to a k-th subspace cluster, and aₖ denotes the number of samples in the k-th subspace cluster;
selecting m negative samples from each of the k subspace clusters to form a diversity-selected negative sample set
$${D}_{diversity}^{N} ,$$
wherein
$${D}_{diversity}^{N} = \{ {C}_{1}^{′} , {C}_{2}^{′} , … , {C}_{k}^{′} \} ,$$
$${C}_{k}^{′} = \{ {X}_{{C}_{k}}^{{1}^{′}} , {X}_{{C}_{k}}^{{2}^{′}} , … , {X}_{{C}_{k}}^{m} \} , and {X}_{{C}_{k}}^{m}$$
denotes a m-th negative sample selected from the k-th subspace cluster;
training a classification network f_{easy-sampling} based on the positive sample set D^{P} and the diversity-selected negative sample set
$${D}_{diversity}^{N} ;$$
and filtering out easy samples from the diversity-selected negative sample set
$${D}_{diversity}^{N}$$
using the classification network f_{easy-sampling}, wherein hard-to-distinguish negative samples left in the diversity-selected negative sample set
$${D}_{diversity}^{N}$$
constitute a negative sample set
$${D}_{select}^{N} ;$$
and
mixing the positive sample set D^{P} and the diversity-selected negative sample set
$${D}_{select}^{N}$$
to obtain a training set
$$D = \{ {D}^{P} , {D}_{select}^{N} \} .$$

4. The method of claim 1, wherein the parent-subclass joint classifier is constructed based on the deep learning network, and comprises an input layer, a feature extractor, a parent-class classifier, a subclass classifier and an output layer;
the input layer is connected to the feature extractor; the feature extractor is connected to the parent-class classifier and the subclass classifier; a fully connected layer of the parent-class classifier is configured as a final fully connected layer to be sequentially connected to the feature extractor and the output layer;
wherein the step (4) comprises:
inputting the training dataset into the input layer; extracting, by the feature extractor, features from the training dataset; and inputting extracted features into the parent-class classifier;
classifying, by the parent-class classifier, the extracted features to obtain the parent-class labels, wherein the parent-class labels comprise a mitotic class and a non-mitotic class;
performing binary classification training on the feature extractor using the training dataset based on the parent-class labels to obtain a preliminarily-trained feature extractor;
extracting, by the preliminarily-trained feature extractor, features of samples from the training dataset to obtain sample features;
clustering, by the subclass classifier, the sample features to divide the mitotic class and the non-mitotic class in the parent-class labels into a plurality of subclasses with the same sample number as the subclass pseudo-labels; and
training the preliminarily-trained feature extractor using the parent-class labels and the subclass pseudo-labels until the loss function converges or an accuracy requirement is met, so as to obtain the parent-subclass joint classifier.

5. The method of claim 4, wherein each of the parent-class labels is represented by c={cₚ, cₙ}, wherein cₚ represents the mitotic class and cₙ represents the non-mitotic class;
samples belonging to each of the parent-class labels c={cₚ, cₙ} are clustered using an unsupervised clustering algorithm into T subclasses
$${S}_{c}^{t} , t = \{ 1 , 2 , … , T \}$$
as the subclass pseudo-labels; and
assuming that a parent-class label for each of the samples in the training dataset is denoted as Y_{P}, a pseudo subclass label corresponding to each of the T subclasses in each of the parent-class labels c is denoted as Y_{S}, and a clustering objective for each of the parent-class labels c is expressed as:
$$min \frac{1}{{N}^{c}} {\sum }_{i = 1}^{{N}^{c}} {min}_{{Y}_{s}} {‖ E ( \hat{D} ) - {OY}_{S} ‖}_{2}^{2} , s . t . {Y}_{S}^{T} {1}_{t} = 1 ;$$
wherein N^{c} is the number of samples in each of the parent-class labels c, Y_{S} is the pseudo subclass label, \hat{D} is the training dataset, E(\hat{D}) represents the features of the training dataset extracted by the feature extractor, O is a matrix composed of centroid coordinates of cells in the training dataset, and 1ₜ represents a t-dimensional identity vector.

6. The method of claim 4, wherein the parent-class classifier and the subclass classifier are supervised using a focal loss function and a center loss function;
a loss function L_{P} for a parent-class classifier f_{P} is defined as:
$${L}_{P} = {L}_{{P}_{f}} + {L}_{{P}_{c}} ;$$
wherein L_{P}_{_{f}} is a focal loss function for the parent-class classifier f_{P}, and L_{P}_{_{c}} is a center loss function for the parent-class classifier f_{P};
a loss function L_{S} for a subclass classifier f_{S} is defined as:
$${L}_{S} = {L}_{{S}_{f}} + {L}_{{S}_{c}} ;$$
wherein L_{S}_{_{f}} is a focal loss function for the subclass classifier f_{S}, and L_{S}_{_{c}} is a center loss function for the subclass classifier f_{S}; and
the feature extractor is optimized using the loss function L_{P} and the loss function L_{S}, and a loss function for the feature extractor is expressed as:
$$min \frac{1}{N} {\sum }_{i = 1}^{N} {L}_{P} ( {f}_{P} ( E ( \hat{D} ) , {θ}_{P} ) , {Y}_{P} ) + λ {L}_{S} ( {f}_{S} ( E ( \hat{D} ) , {θ}_{S} ) , {Y}_{S} ) ;$$
wherein N is the number of samples in the training dataset, \hat{D} is the training dataset, E(\hat{D}) represents the features of the training dataset extracted by the feature extractor, λ is a balancing parameter, θ_{P} is a parameter of the parent-class classifier f_{P}, θ_{S} is a parameter of the subclass classifier f_{S}, Y_{P} is a parent-class label, and Y_{S} is a pseudo subclass label.

7. The method of claim 6, wherein the focal loss function is expressed as:
$${L}_{F} = - {\sum }_{i} [ {( 1 - \hat{{y}_{ι}} )}^{γ} {y}_{i} log \hat{{y}_{ι}} + {( \hat{{y}_{ι}} )}^{γ} ( 1 - {y}_{i} ) log ( 1 - \hat{{y}_{ι}} ) ] ;$$
wherein yⁱ represents a label of an i-th sample in the training dataset, and ŷᵢ represents a prediction of the i-th sample in the training dataset, and γ is an adjustable parameter for controlling a weight of misclassified samples; and
the center loss function is expressed as:
$${L}_{C} = \frac{1}{2} {\sum }_{i = 1}^{N} {‖ {x}_{i} - {c}_{{y}_{i}} ‖}_{2}^{2} ;$$
wherein xᵢ is a feature vector of the i-th sample in the training dataset, yᵢ is a subclass label corresponding to the feature vector xᵢ, N is the number of samples in the training dataset, and c_{y}_{ᵢ} is a center of an i-th subclass.

8. A system for implementing the method of claim 1, comprising:
a staining detection module;
a sample selection module;
a data augmentation module;
a classifier training module; and
a detection result module;
wherein the staining detection module is configured to perform:
acquiring the pathological image and point annotations of the pathological image;
performing HE staining on the pathological image to obtain the stained pathological image;
processing the stained pathological image by color deconvolution to obtain the hematoxylin-stained channel image; and
dividing the hematoxylin-stained channel image into image patches as candidate cells, and classifying the candidate cells into the positive sample set and the negative sample set;
the sample selection module is configured to perform:
filtering out redundant samples and easy samples from the negative sample set; and
mixing remaining samples in the negative sample set with the positive sample set to obtain the training set;
the data augmentation module is configured to perform:
expanding the training set into k color spaces followed by mixing with the training set to form the training dataset;
the classifier training module is configured to perform:
clustering the training dataset based on the deep learning network using parent-class labels to obtain subclass pseudo-labels; and
optimizing the deep learning network based on the parent-class labels and the subclass pseudo-labels until the loss function converges, so as to obtain the parent-subclass joint classifier; and
the detection result module is configured to detect mitosis in the to-be-detected pathological image using the parent-subclass joint classifier to obtain the detection result.

9. An electronic device, comprising:
at least one processor; and
a memory communicatively coupled to the at least one processor;
wherein the memory is configured for storing computer program instructions executable by the at least one processor; and the computer program instructions are configured to be executed by the at least one processor to implement the method of claim 1.

10. A non-transitory computer-readable storage medium, wherein the non-transitory computer-readable storage medium is configured for storing a computer program; and the computer program is configured to be executed by a processor to implement the method of claim 1.
